(19) United States
(12) Patent Application Publication
(10) Pub. No.: US 2023/0213275 A1
(43) Pub. Date: Jul. 6, 2023

(54) DEVICES, SYSTEMS, FACILITIES AND PROCESSES FOR CO2 CAPTURE/SEQUESTRATION AND PYROLYSIS BASED HYDROGEN GENERATION FROM BLAST FURNACE FACILITIES

(71) Applicant: NEXT CARBON SOLUTIONS, LLC, Houston, TX (US)

(72) Inventors: Vikrum Subra, Houston, TX (US); Ivan Van der Walt, Conroe, TX (US); Ben Heichelbech, Houston, TX (US)

(21) Appl. No.: 17/992,547

(22) Filed: Nov. 22, 2022

Related U.S. Application Data
(60) Provisional application No. 63/282,932, filed on Nov. 24, 2021.

(51) Int. Cl. F25J 1/02; C01B 32/50; F25J 1/00; B01D 53/04; B01D 53/14; F25J 3/08; B01D 53/34

(52) U.S. Cl. CPC F25J 1/0229; C01B 32/50; F25J 1/0027; B01D 53/0423; B01D 53/1475; F25J 1/0283; F25J 3/08; F25J 1/0282; F25J 1/0284; B01D 53/343; C01B 2203/02; B01D 2257/504; F25J 2205/50; F25J 2220/60; F25J 2260/80; F25J 2290/62; F25J 2290/72; B01D 2256/16

(57) ABSTRACT

A blast furnace facility includes a process for capturing and sequestering CO2 generated from the facility process, producing hydrogen from the hot blast furnace gas, and using blast furnace gas as methanol feed. The CO2 rich streams from the facility may be sent to sequestration of some form via a sequestration compressor, thereby reducing the overall emissions from the facility. The other products generated by the facility are used as methanol feedstock and to produce hydrogen.

### CROSS REFERENCE TO RELATED APPLICATIONS

The present application claims the benefit of priority to U.S. Provisional Application No. 63/282,932 filed Nov. 24, 2021, the entirety of which is incorporated herein by reference.

### BACKGROUND

Blast furnace facilities contribute to greenhouse gases through the various processes. Greenhouse gases comprise various gaseous components such as carbon dioxide, methane, nitrous oxide, hydrofluorocarbons, perfluorocarbons and sulfur hexafluoride that absorb radiation, trap heat in the atmosphere and generally contribute to undesirable environmental green-house effects.

Blast furnace facilities often implement certain forms of hydrocarbon reduction technologies such as scrubbers and flares, or reuse of the blast furnace gas as part of a combined cycle power plant. However, typically these facilities do not have a dedicated process specifically designed to reduce most greenhouse gas emissions.

Blast furnace facilities need to improve the overall efficiency of the facility and reduce greenhouse gas emissions.

### SUMMARY

A blast furnace facility may include several flue gas streams from various parts of the facility, each containing some concentration of CO2, which typically would be released to the atmosphere. The blast furnace facility of the present disclosure includes devices and systems for capturing and/or sequestrating CO2 and for generating hydrogen using a methane pyrolysis system.

In a first aspect of the present disclosure, which may be combined with any other aspect listed herein unless specified otherwise, the blast furnace facility includes a duct firing system that may increase the temperature and mass flow of the flue gas.

In a second aspect of the present disclosure, which may be combined with any other aspect listed herein unless specified otherwise, the flue gas from the duct firing system may be sent to a Heat Recovery Steam Generator (HRSG) unit configured to produce steam from the increased temperature and mass of the flue gas. The steam produced by the HRSG unit may be sent to a power generator to power the CCS facility users, with the excess power being sold to the grid. Additionally, the steam may be sent to the CCS steam users, such as a regenerator reboiler, to be used in the process, and/or may be sent to the methane pyrolysis unit, and/or can be used for CCS facility power.

In a third aspect of the present disclosure, which may be combined with any other aspect listed herein unless specified otherwise, the flue gas from the HRSG unit may be sent to a gas/air heat exchanger to be cooled via ambient air. Ambient air is provided from an air blower which may be electric or steam driven. The hot ambient air downstream of the gas/air heat exchanger is released to the atmosphere.

In a fourth aspect of the present disclosure, which may be combined with any other aspect listed herein unless specified otherwise, the cooled flue gas from the gas/air heat exchanger may be sent to the CO2 absorber. The CO2 absorber may include a commercially available absorbing media for CO2, such as amine, ammonia, ionic fluids, sodium carbonate, methanol, potassium chloride, or any other industrially available solvents, in, for example, an absorber column. The treated gas from the CO2 absorber may be released to the atmosphere with less than 5% CO2 of the initial flue gas stream.

In a fifth aspect of the present disclosure, which may be combined with any other aspect listed herein unless specified otherwise, the rich solvent from the CO2 absorber may be sent to a CO2 regenerator to be processed. Lean solvent may be sent back to the CO2 absorber for CO2 absorption. The CO2 rich gas stream from the CO2 regenerator may then be sent to the sequestration compressor unit and/or may be sent to the methanol feed header.

In a sixth aspect of the present disclosure, which may be combined with any other aspect listed herein unless specified otherwise, the sequestration compression unit includes an electric, steam, supercritical CO2, or gas driven sequestration compressor configured to compresses the CO2 rich gas stream to be sent to be transported via pipeline, truck, train, or rail.

In a seventh aspect of the present disclosure, which may be combined with any other aspect listed herein unless specified otherwise, the CO2 is transported to a sequestration site either on land, sea, in a geological formation containing a saline aquifer, or to be used for enhanced oil recovery.

In an eighth aspect of the present disclosure, which may be combined with any other aspect listed herein unless specified otherwise, the CO2 can be transported as a feedstock for other industrial users.

In a ninth aspect of the present disclosure, which may be combined with any other aspect listed herein unless specified otherwise, the CO2 can be sent to a storage tank to be combined with aggregate CO2, to be used in syngas production, or to be used in power production. For power production, the liquid CO2 may act as a “peak shaving” facility and evaporate the liquid CO2 as power is required. This liquid CO2 may be expanded into gas to drive a set of turbines to generate electricity. The gas may then be returned to a dome to be stored and compressed into liquid to start the cycle again.

In a tenth aspect of the present disclosure, which may be combined with any other aspect listed herein unless specified otherwise, the hot blast furnace exhaust may be sent to a gas heating medium exchanger configured to derive heat from the hot blast furnace gas and direct the heat to the methane pyrolysis unit.

In an eleventh aspect of the present disclosure, which may be combined with any other aspect listed herein unless specified otherwise, the cooled gas from the gas/heating medium exchanger is sent to plant and CCS heat users.

In a twelfth aspect of the present disclosure, which may be combined with any other aspect listed herein unless specified otherwise, the cooled blast furnace gas from the plant users may be sent to the methanol feed header, as the cooled blast furnace gas includes CO2, CO and H2.

In a thirteenth aspect of the present disclosure, which may be combined with any other aspect listed herein unless specified otherwise, the methane pyrolysis unit produces hydrogen and carbon from feed gas and the heat generated by the gas/heating medium exchanger.

In a fourteenth aspect of the present disclosure, which may be combined with any other aspect listed herein unless specified otherwise, the hydrogen produced at the methane pyrolysis unit may be sent to transport for market which includes pipeline, rail, truck and ship and/or to a methanol feed header.

In a fifteenth aspect of the present disclosure, which may be combined with any other aspect listed herein unless specified otherwise, the carbon (C) generated by the methane pyrolysis unit may be sent to transportation to market. This carbon can be used for fertilizer, to make activated carbon, and other uses for solid carbon.

In a sixteenth aspect of the present disclosure, which may be combined with any other aspect listed herein unless specified otherwise, the feedstock at the methanol feed header may include an optimal ratio of H2, CO and CO2 and may be sent to transport including pipeline, rail, truck and ship to be sent to a methanol facility as feed.

Additional features and advantages of the disclosed devices, systems, and methods are described in and will be apparent from the following Detailed Description and the FIGURES. The features and advantages described herein are not all-inclusive and in particular many additional features and advantages will be apparent to one of ordinary skill in the art in view of the figures and description. Also, any particular embodiment does not have to have all of the advantages listed herein. Moreover, it should be noted that the language used in the specification has been principally selected for readability and instructional purposes, and not to limit the scope of the inventive subject matter.

### BRIEF DESCRIPTION OF THE FIGURES

Understanding that the FIGURES depict only typical embodiments of the present disclosure and are not to be considered to be limiting the scope of the present disclosure, the present disclosure is described and explained with additional specificity and detail through the use of the accompanying FIGURE.

FIG. 1 illustrates an exemplary schematic of a blast furnace facility configured to direct flue gas to sequestration/storage.

### DETAILED DESCRIPTION OF EXAMPLE EMBODIMENTS

The detailed description is to be construed as exemplary only and does not describe every possible embodiment, as describing every possible embodiment would be impractical, if not impossible. One of ordinary skill in the art could implement numerous alternate embodiments, which would still fall within the scope of the claims. To the extent that any term is referred to in a manner consistent with a single meaning, that is done for the sake of clarity and illustration only, and it is not intended that such claim term be limited to that single meaning.

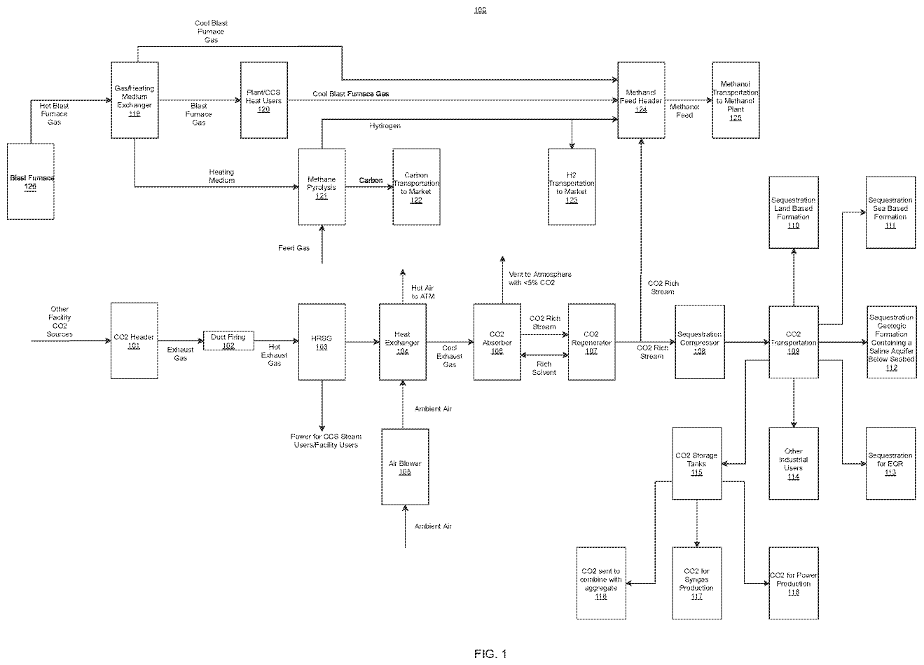

FIG. 1 illustrates an exemplary schematic of a blast furnace facility 100 with the flue gas from the facility being sent to sequestration, storage, out for methanol production and/or to market.

Blast furnace plant CO2 sources including the emissions from the blast furnace 126 outside of the hot blast furnace gas may be directed to the CO2 Header 101. As used in this specification, the term “blast furnace plant CO2 sources” includes all the CO2 sources from the plant except the blast furnace gas. This gas may be combined in the CO2 header 101 and sent to a duct firing 102, where the temperature and mass flow of the flue gas may be increased. The flue gas may then be sent to a Heat Recovery Steam Generator (HRSG) unit 103, which may generate synchronous power for the power grid and/or steam for carbon capture and storage (CCS) facility users.

The flue gas from the HRSG unit 103 may be sent to a heat exchanger 104 to reduce the temperature prior to CO2 absorption. In some embodiments, the heat exchanger 104 may be a gas/air heat exchanger, and air may be provided to the heat exchanger 104 by an electric or steam driven air blower 105, which may be sized accordingly to blow ambient air through the heat exchanger 104. Hot ambient air may be released to the atmosphere. In some embodiments, the heat exchanger 104 may be a direct contact cooler utilizing water as the cooling medium for the flue.

Cooled flue gas from the heat exchanger 104 may be sent to a CO2 absorber 106, where the CO2 may be absorbed through a commercially available absorbent media. Examples of absorbing media include amine, ammonia, ionic fluids, sodium carbonate, methanol, potassium chloride, and/or any other available industrial solvents. The treated gas containing less than about 5% CO2 may be vented to the atmosphere. This CO2 absorber 106 may be designed to achieve about 50% turndown capacity while still achieving a capture rate of about 95%.

The CO2 rich gas stream and/or the rich solvent-containing CO2 gas may then be sent to a CO2 regenerator 107, where the CO2 may be separated from the solvent using heat or another form of energy. Solvent having undergone the regeneration process at the CO2 regenerator 107 may be returned to the CO2 absorber 106. The CO2 rich gas stream from the CO2 regenerator 107 may be sent to a sequestration compressor unit 108 and/or to a methanol feed header 124. The sequestration compression unit 108 may include one or more knockout drums for collecting any remaining liquid in the gas stream and at least one compressor that may be steam, electric, or supercritical CO2 driven and configured to compress the carbon dioxide rich stream. This sequestration compressor may be designed to achieve about 50% turndown capacity while still sequestering the full amount of CO2.

The compressed CO2 rich stream may be sent to CO2 transportation 109 (pipeline, truck, rail, ship, etc.) and then to off-site sequestration. The offsite sequestration may be storage in a land based formation 110, a sea based formation 111, a geological formation containing a saline aquifer below the seabed 112, or in a partially depleted hydrocarbon reservoir for enhance oil recovery (EOR) 113. For example, the sequestration site may be a region below a seabed, wherein the seabed is located at a depth greater than about 3.0 kilometers below sea level. Furthermore, the compressed CO2 may be sent to other industrial users 114 for feedstock. If the CO2 is sent to storage tanks 115, it can be further combined with aggregate CO2 for other uses 116, used for syngas production 117, and/or to be used in power production 118. For power production, the liquid CO2 which is stored can act as a “peak shaving” facility and evaporate the liquid CO2 as power is required. This liquid CO2 is expanded into gas to drive a set of turbines to generate electricity. The gas may be returned to a dome to be stored and compressed into liquid to start the cycle again.

As shown in FIG. 1, the hot blast furnace gas from the blast furnace 126 may be sent to a gas/heating medium exchanger 119 in order to generate heat. The heat from the gas/heating medium exchanger 119 along with methane-containing feed gas may be sent to a methane pyrolysis unit 121.

The methane pyrolysis unit 121 may utilize the feed gas and the heating medium to generate hydrogen and carbon. The carbon (C) produced from the methane pyrolysis unit 121 may be sent to a transportation to market 122 and may be used for activated carbon, fertilizer, and other uses that involve solid carbon. The hydrogen may be sent to transportation to market 123 and/or a methanol feed header 124.

The hot blast furnace gas from the gas/heating medium exchanger 119 may be sent to other plant/CCS heat users/cooler 120 if necessary to utilize some of the excess heat. The cooled blast furnace gas may be sent directly to the methanol feed header 124, as it includes hydrogen, carbon monoxide and carbon dioxide, which are the constituents of methanol feed gas. The methanol feed gas from the methanol feed header 124 may be sent to methanol transportation 125 which ultimately may be sent to a methanol plant as feed.

The system 100 may also include ancillary heating equipment that may run full time to support the heating requirements of the carbon capture facility. This support may be needed to handle a turndown of about 0-50% with a low capture yield and a fast response on increased capture rate when the system is ramped up.

By sending the carbon dioxide rich stream to some form of sequestration, utilizing the blast furnace gas and hydrogen production to make high value products such as methanol, overall greenhouse gas emissions from facility 100 are reduced.

All percentages expressed herein are by weight of the total weight of the composition unless expressed otherwise. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in this disclosure and the appended claims, the singular forms “a,” “an” and “the” include plural referents unless the context clearly dictates otherwise. Thus, for example, reference to “an ingredient or “the ingredient” means “at least one ingredient” and includes two or more ingredients.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified. A composition “consisting essentially of” contains at least 75 wt. % of the referenced components, preferably at least 85 wt. % of the referenced components, more preferably at least 95 wt. % of the referenced components, most preferably at least 98 wt. % of the referenced components.

The terms “at least one of” and “and/or” used in the respective context of “at least one of X or Y” and “X and/or Y” should be interpreted as “X,” or “Y,” or “X and Y.” For example, “at least one of honey or chicory root syrup” should be interpreted as “honey without chicory root syrup,” or “chicory root syrup without honey,” or “both honey and chicory root syrup.”

Where used herein, the terms “example” and “such as,” particularly when followed by a listing of terms, are merely exemplary and illustrative and should not be deemed to be exclusive or comprehensive.

The many features and advantages of the present disclosure are apparent from the written description, and thus, the appended claims are intended to cover all such features and advantages of disclosure. Further, since numerous modification and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable no or in the future.

We claim:

1. A system for treating, compressing, and sequestering carbon dioxide (CO2) derived from flue gas of a blast furnace facility, producing hydrogen, and using blast furnace gas as methanol feed, the system comprising:
a Heat Recovery Steam Generator (HRSG) unit configured to receive the flue gas and to generate steam;
a heat exchanger configured to cool the flue gas from the HRSG unit;
a CO2 absorber configured to receive the flue gas from the heat exchanger, the CO2 absorber including an absorbent for absorbing CO2 from the flue gas;
a sequestration compression unit comprising a sequestration compressor, the sequestration compressor being one of gas driven, electric driven, or steam driven, wherein the sequestration compression unit is configured to compress the flue gas into at least one CO2 rich stream and to convey the at least one CO2 rich stream towards a sequestration site;
a gas/heating medium exchanger unit configured to receive the blast furnace gas and to generate heat;
a methane pyrolysis unit configured to produce hydrogen and carbon from feed gas and the heat provided from the gas/heating medium exchanger unit, wherein a portion of the hydrogen is sent to a methanol feed header; and
the methanol feed header configured to receive the blast furnace gas directly or indirectly from the gas/heating medium exchanger unit, the portion of the hydrogen from the methane pyrolysis unit, and a portion of the flue gas from downstream of the CO2 absorber.

2. The system of claim 1, further comprising a duct firing unit configured to receive the flue gas from process units of the blast furnace facility, wherein the duct firing unit is configured to increase a temperature and a mass flow of the flue gas.

3. The system of claim 1, wherein the heat exchanger comprises a gas/air heat exchanger utilizing ambient air to cool the flue gas.

4. The system of claim 1, wherein steam generated by the HRSG unit is utilized by a power generator to provide power and/or sell power to a power grid.

5. The system of claim 1, wherein the sequestration compressor is gas driven, and wherein exhaust gas from the sequestration compressor is directed to the CO2 absorber.

6. The system of claim 1, wherein the sequestration site is selected from the group consisting of a region below a seabed, a region on top of a seabed and located at a depth greater than about 3.0 kilometers below a sea level, a region in a geological formation containing a saline aquifer below the seabed, existing wells for enhanced oil recovery, and combinations thereof.

7. The system of claim 1, wherein a further CO2 rich stream from the sequestration compressor unit is transported to at least one industrial user.

8. The system of claim 1, comprising one or more storage tanks configured to store a further CO2 rich stream downstream of the sequestration compressor unit.

9. A process for treating, compressing, and sequestering carbon dioxide (CO2) derived from flue gas of a blast furnace facility, producing hydrogen, and using blast furnace gas as methanol feed, the process comprising:
receiving, at a Heat Recovery Steam Generator (HRSG) unit, the flue gas from process units of the blast furnace facility and generating steam;
cooling, at a heat exchanger, the flue gas from the HRSG unit;
absorbing, at a CO2 absorber, CO2 from the flue gas;
compressing, at a sequestration compression unit, the flue gas;
conveying, by the sequestration compression unit, the compressed flue gas towards at least one of a sequestration site, a storage tank, or at least one industrial user;
receiving, at a gas/heating medium exchanger unit, the blast furnace gas and generating heat from the blast furnace gas;
receiving, at a methane pyrolysis unit, the heat from the gas/heating medium exchanger unit and a feed gas;
producing, at the methane pyrolysis unit, hydrogen and carbon from the feed gas and the heat from the gas/heating medium exchanger unit.

10. The process of claim 9 comprising receiving, at a methanol feed header, the blast furnace gas, hydrogen from the methane pyrolysis unit, and flue gas directly or indirectly from the CO2 absorber.

11. The process of claim 9, wherein the sequestration compression unit comprises a sequestration compressor, the sequestration compressor is gas driven, and the process comprises directing exhaust gas from the sequestration compressor to the CO2 absorber.

12. The process of claim 9 comprising transporting a further CO2 rich stream from the sequestration compressor unit to at least one industrial user.

13. The process of claim 9 comprising utilizing steam generated by the HRSG unit by a power generator to provide power and/or sell power to a power grid.

14. The process of claim 9, wherein the sequestration site is selected from the group consisting of a region on top of a seabed and located at a depth greater than about 3.0 kilometers below a sea level, a region below a seabed, a region in a geological formation containing a saline aquifer below the seabed, existing wells for enhanced oil recovery, and combinations thereof.

15. A process for treating, compressing, and sequestering carbon dioxide (CO2) derived from flue gas of a blast furnace facility, producing hydrogen, and using blast furnace gas as methanol feed, the process comprising:
receiving, at a duct firing unit, the flue gas from process units of the blast furnace facility, and increasing a temperature and a mass flow of the flue gas;
receiving, at a Heat Recovery Steam Generator (HRSG) unit, the flue gas from the duct firing unit and generating steam;
cooling, at a heat exchanger, the flue gas from the HRSG unit;
absorbing, at a CO2 absorber, CO2 from the flue gas from the gas/air heat exchanger and absorbing CO2 from the flue gas;
compressing, at a sequestration compression unit, the flue gas from the CO2 absorber;
conveying, by the sequestration compression unit, the compressed flue gas towards at least one of a sequestration site, a storage tank, or at least one industrial user;
receiving, at a gas/heating medium exchanger unit, the blast furnace gas and generating heat from the blast furnace gas;
receiving, at a methane pyrolysis unit, the heat from the gas/heating medium exchanger unit;
producing, at the methane pyrolysis unit, hydrogen and carbon from feed gas and the heat from the gas/heating medium exchanger unit; and
receiving, at a methanol feed header, the blast furnace gas from the gas/heating medium exchanger unit, the hydrogen from the hydrogen from the methane pyrolysis unit, and a portion of the flue gas from downstream of the CO2 absorber.

16. The process of claim 15, further comprising receiving, by a power generator, steam generated by the HRSG unit and providing power to a power grid.

17. The process of claim 15, wherein the sequestration site is selected from the group consisting of a region on top of a seabed and located at a depth greater than about 3.0 kilometers below a sea level, a region below a seabed, a region in a geological formation containing a saline aquifer below the seabed, existing wells for enhanced oil recovery, and combinations thereof.

18. The process of claim 15, wherein the sequestration compressor is gas driven, the process comprising directing exhaust gas from the sequestration compressor to the CO2 absorber.
